(19) United States
(12) Patent Application Publication
(10) Pub. No.: US 2017/0063169 A1
(43) Pub. Date: Mar. 2, 2017

(54) RECEIVER DETUNING COMPENSATION USING TRANSMITTER FERRITE

(71) Applicant: QUALCOMM Incorporated, San Diego, CA (US)

(72) Inventors: Wojciech Grzegorz Stanislawski, Valley Center, CA (US); William Henry Von Novak, III, San Diego, CA (US)

(21) Appl. No.: 15/247,060

(22) Filed: Aug. 25, 2016

Related U.S. Application Data
(60) Provisional application No. 62/210,283, filed on Aug. 26, 2015.

(51) Int. Cl. H02J 50/70; H02J 7/02; H02J 50/12

(52) U.S. Cl. CPC H02J 50/70; H02J 50/12; H02J 7/025

(57) ABSTRACT

An apparatus for wireless power transfer includes: a support member including a charging surface configured to support a power receiving element; a power transmitting element configured to generate a magnetic field that can wirelessly transfer power to the power receiving element; a metallic shield disposed such that the power transmitting element is disposed between the support member and the metallic shield, the metallic shield being configured to inhibit the magnetic field generated by the power transmitting element; and ferrite pieces spaced apart from each other and disposed between the power transmitting element and the metallic shield and closer to the metallic shield than to the power transmitting element, the ferrite pieces offsetting an effect of the metallic shield on a reactance of the power receiving element.

### CROSS-REFERENCE TO RELATED APPLICATIONS

This application claims the benefit of U.S. Provisional Application No. 62/210,283, filed Aug. 26, 2015, entitled “RECEIVER DETUNING COMPENSATION USING TRANSMITTER FERRITE,” the entire contents of which are hereby incorporated herein by reference.

### TECHNICAL FIELD

The disclosure relates generally to wireless power delivery to electronic devices, and in particular to selective power transmitting element use for wireless power transfer.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic device.

Wireless power transfer systems may include a power transmitting unit and one or more power receiving units, for example, mobile devices such as smartphones, computer tablets, and so on. Both the power transmitting unit and the power receiving unit, each, may include a tuned resonator system that includes a coil and is tuned at or close to a resonant frequency. Structures within one device (e.g., power transmitting unit) may detune the resonator system in the power receiving unit.

### SUMMARY

In accordance with aspects of the disclosure, an apparatus for wireless power transfer may include: a support member including a charging surface configured to support a power receiving element; a power transmitting element configured to generate a magnetic field that can wirelessly transfer power to the power receiving element; a metallic shield disposed such that the power transmitting element is disposed between the support member and the metallic shield, the metallic shield being configured to inhibit the magnetic field generated by the power transmitting element; and ferrite pieces spaced apart from each other and disposed between the power transmitting element and the metallic shield and closer to the metallic shield than to the power transmitting element, the ferrite pieces offsetting an effect of the metallic shield on a reactance of the power receiving element.

In accordance with aspects of the disclosure, a method for wireless power transfer may include: generating, from a power transmitting element, a magnetic field for wireless transfer of power to a power receiving element above the power transmitting element; shielding the magnetic field below the power transmitting element using a metal layer, the metal layer influencing a value of a reactance of the power receiving element in a first direction; and locally influencing the value of the reactance of the power receiving element in a second direction at a plurality of locations across the power receiving element to compensate for the influence of the metal layer on the value of the reactance of the power receiving element.

In accordance with aspects of the disclosure, an apparatus may include: means for supporting a power receiving element; means for generating a magnetic field for wireless transfer of power to the power receiving element; means for shielding the magnetic field, the means for shielding configured to have a detuning influence on the power receiving element to influence a resonant frequency of the power receiving element away from a desired resonant frequency; and means for locally retuning the power receiving element at a plurality of locations on the shielding means to influence the resonant frequency of the power receiving element toward the desired resonant frequency.

In accordance with aspects of the disclosure, a method for wireless power transfer may include generating a magnetic field for wireless transfer of power to a power receiving element. The method may further include shielding the magnetic field from users using a metal layer. The metal layer may have an effect that changes a value of a reactance of the power receiving element in a first direction. The value of the reactance of the power receiving element may be changed locally in a second direction at a plurality of locations across the entire surface of the metal layer to compensate for the effect of the metal layer on the power receiving element.

In some aspects, locally changing the value of the reactance of the power receiving element may include changing the value in a direction opposite the first direction.

In some aspects, the metal layer may have an effect that decreases the reactance of the power receiving element. Locally changing the value of the reactance of the power receiving element may include increasing the reactance of the power receiving element.

In some aspects, locally changing the value of the reactance of the power receiving element may include disposing a plurality of spaced apart ferrite pieces between a coil that generates the magnetic field and the metal layer. In some aspects, each piece of ferrite material may be smaller than a coil of the power receiving element. In some aspects, the plurality of ferrite pieces may have a regular shape. In some aspects, the plurality of ferrite pieces may be the same size as each other. In some aspects, the plurality of ferrite pieces may encompass substantially the entire area of the metal layer. In some aspects, the area of the plurality of ferrite pieces may be substantially the same size as the area of a charging surface on which the power receiving element is placed. For example, the ferrite pieces may cover (not including the spacings) over 75% of a length of the charging surface, over 75% of a width of the charging surface, over 75% of a length of the metal layer, and/or over 75% of a width of the metal layer, and may extend (including the spacings) over 85% of a length and/or width of the metal layer or the charging surface. As other examples, a cumulative area of the ferrite pieces may cover (excluding the spacings) more than 50% of an area of the charging surface and/or over 50% of an area of the charging surface or the metal layer and may extend (including the spacings) over 80% of the area of the charging surface or the metal layer.

In accordance with aspects of the disclosure, a method for wireless power transfer may include generating a magnetic field for wireless transfer of power to a power receiving element. The method may further include shielding the magnetic field from users using a metal layer. The metal layer may have an effect that detunes the power receiving element away from a resonance frequency of the power receiving element. Accordingly, the method may include locally compensating for a detuning effect of the metal layer on the power receiving element at a plurality of locations across the entire surface of the metal layer to retune the power receiving element.

In some aspects, locally compensating for the detuning effect of the metal layer may include changing a value of a reactance of the power receiving element.

In some aspects, the metal layer has an effect that decreases the reactance of the power receiving element.

In some aspects, locally compensating for the detuning effect of the metal layer may include increasing the reactance of the power receiving element.

In some aspects, locally compensating for the detuning effect of the metal layer includes disposing a plurality of spaced apart ferrite pieces between a coil that generates the magnetic field and the metal layer.

In accordance with aspects of the disclosure, an apparatus may include a charging surface for supporting at least one power receiving element, a power transmitting element spaced apart from the charging surface. The power transmitting element may be configured to generate a magnetic field that can wirelessly transfer power to the power receiving element. The apparatus may further include a metallic sheet spaced apart from the power transmitting element. The metallic sheet may have an effect on a reactance of the power receiving element. The apparatus may include a plurality of ferrite pieces spaced apart from each other and disposed between the power transmitting element and the metallic sheet. The plurality of ferrite pieces may have an effect that offsets the effect of the metallic sheet on the reactance of the power receiving element.

In some aspects, the effect of the metallic sheet on the reactance of the power receiving element may change the value of the reactance in a first direction. The effect of the plurality of ferrite pieces may change the value of the reactance in a direction opposite the first direction.

In some aspects, each of the plurality of ferrite pieces may be smaller than a coil that comprises the power receiving element. In some aspects, the plurality of ferrite pieces may have a regular shape. In some aspects, the plurality of ferrite pieces may be the same size as each other. In some aspects, the area of the plurality of ferrite pieces and the area of the metal layer may be substantially the same size. In some aspects, the area of the plurality of ferrite pieces may be substantially the same size as the area of the charging surface.

In some aspects, the metal layer may reduce the reactance of the power receiving element. In some aspects, the plurality of ferrite pieces may increase the reactance of the power receiving element.

In accordance with aspects of the disclosure, an apparatus may include first means for supporting a power receiving element, second means for generating a magnetic field for wireless transfer of power to a power receiving element, third means for shielding the magnetic field from any users, the third means having an effect on the power receiving element that detunes the power receiving element from a resonant frequency of the power receiving element, and fourth means for locally retuning the power receiving element at a plurality of locations on the third means.

The following detailed description and accompanying drawings provide a better understanding of the nature and advantages of the disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced. In the accompanying drawings:

FIG. 1 is a functional block diagram of a wireless power transfer system in accordance with an illustrative embodiment.

FIG. 2 is a functional block diagram of a wireless power transfer system in accordance with an illustrative embodiment.

FIG. 3 is a schematic diagram of a portion of transmit circuitry or receive circuitry of FIG. 2 including a power transmitting or receiving element in accordance with an illustrative embodiment.

FIG. 4 illustrates a transmitter and a receiver.

FIG. 5 shows a cross-sectional view of the transmitter.

FIGS. 5A and 5B illustrate cross-sectional views of transmitters for comparison purposes.

FIGS. 6A and 6B show illustrative embodiments of a transmitter in accordance with the disclosure.

FIG. 7 shows details of a layer of ferrite in accordance with the disclosure.

FIGS. 7A, 7B, 7C, 7D, 7E show alternate shapes and arrangements for pieces of ferrite in accordance with the disclosure.

FIG. 8 shows an aspect of the layer of ferrite in accordance with the disclosure.

### DETAILED DESCRIPTION

In the following description, for purposes of explanation, numerous examples and specific details are set forth in order to provide a thorough understanding of the disclosure. It will be evident, however, to one skilled in the art that the disclosure as expressed in the claims may include some or all of the features in these examples, alone or in combination with other features described below, and may further include modifications and equivalents of the features and concepts described herein.

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

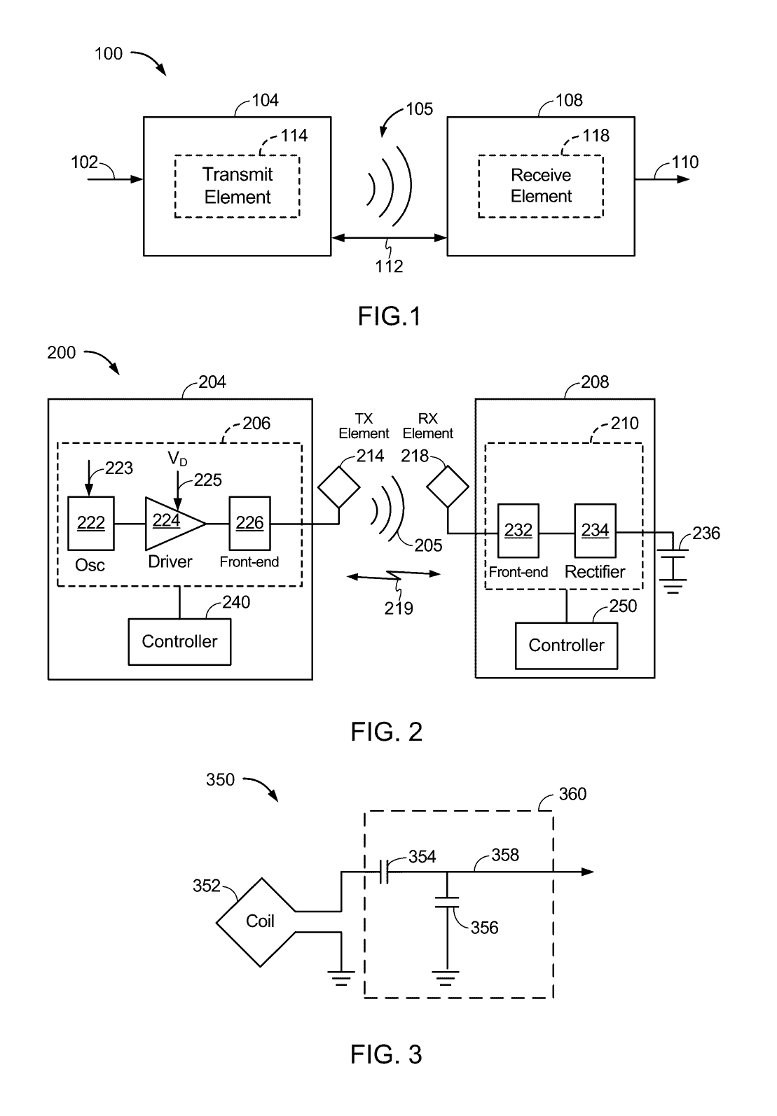

FIG. 1 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 2 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power receiving element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power receiving element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer. The memory would thus be a machine-readable medium.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

Often, designers of power transmitting units (transmitters) add shielding to reduce electromagnetic interference (EMI) and/or exposure of a user to the charging field produced by the power transmitting unit. For example, a shield on the bottom of the transmitter could reduce the field that a user's legs might be exposed to, if they were sitting at a table with the transmitter on top.

When shielding is added to a transmitter, there may be effects in addition to the desired shielding effects. For example, the shielding (e.g., metal shielding) may cause detuning of the coil in the power receiving unit (receiver). Since metal affects the inductance of nearby structures, the inductance of the receiver can be changed. This detuning can be problematic in several ways, including increase in peak power point resistance and change in output voltage.

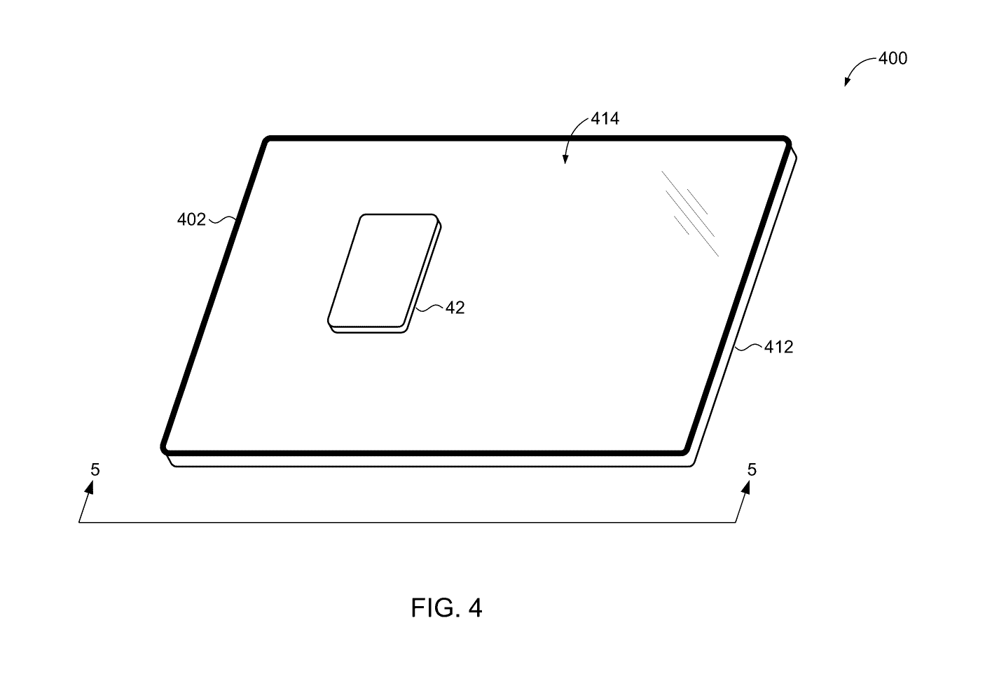

FIG. 4 shows an example of a wireless power transfer system 400 comprising a transmitter 402 in accordance with the disclosure and a receiver 42. Receiver 42 may be any portable electronic device such as a computer tablet, a smartphone, a digital camera, an audio device, and so on. The transmitter 402 may include a housing 412 to contain components (not shown) that comprise the transmitter 402. The transmitter 402 may include means for supporting a receiver 42. In some embodiments, for example, the transmitter 402 may include an upper surface (charging surface) 414 for on which receiver 42 may be supported or placed for wireless power transfer; e.g., in order to charge a battery in the receiver 42, provide power to operate receiver 42, and so on.

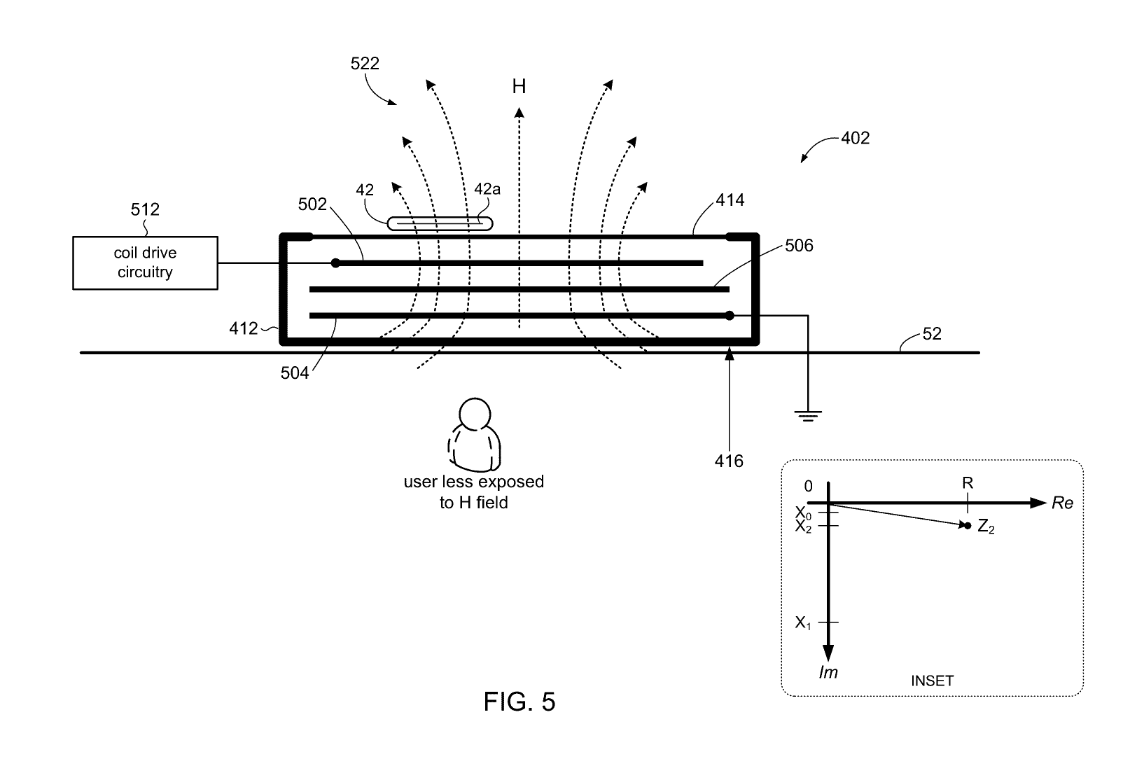

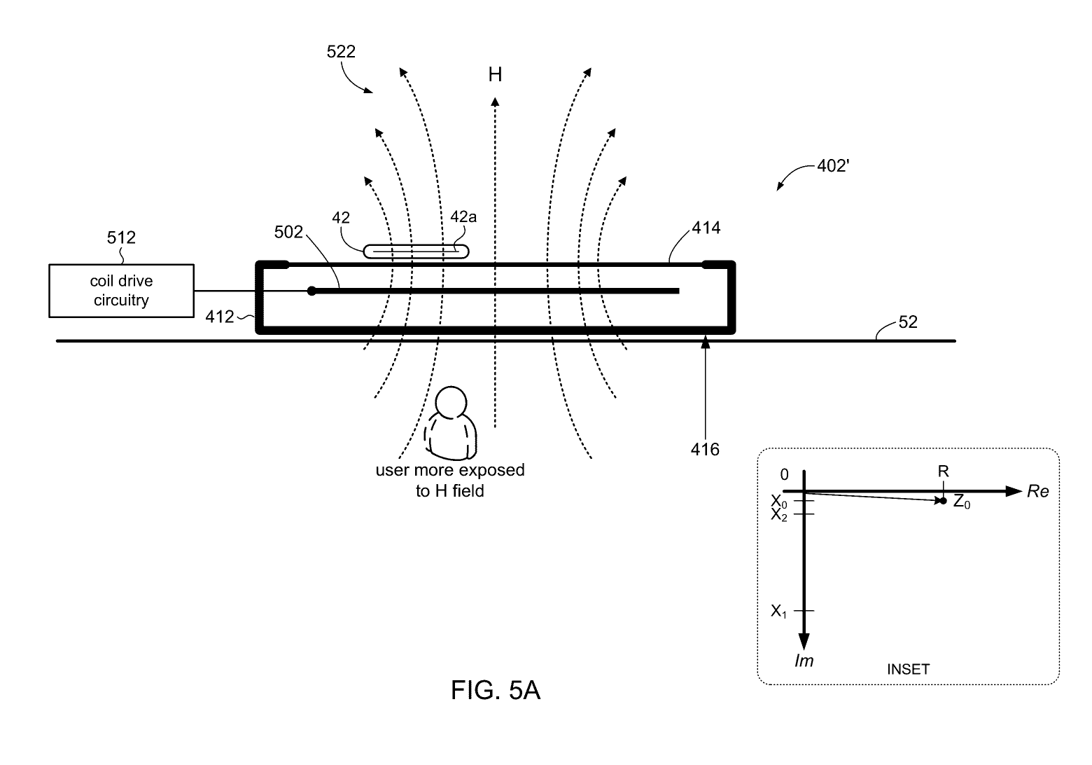

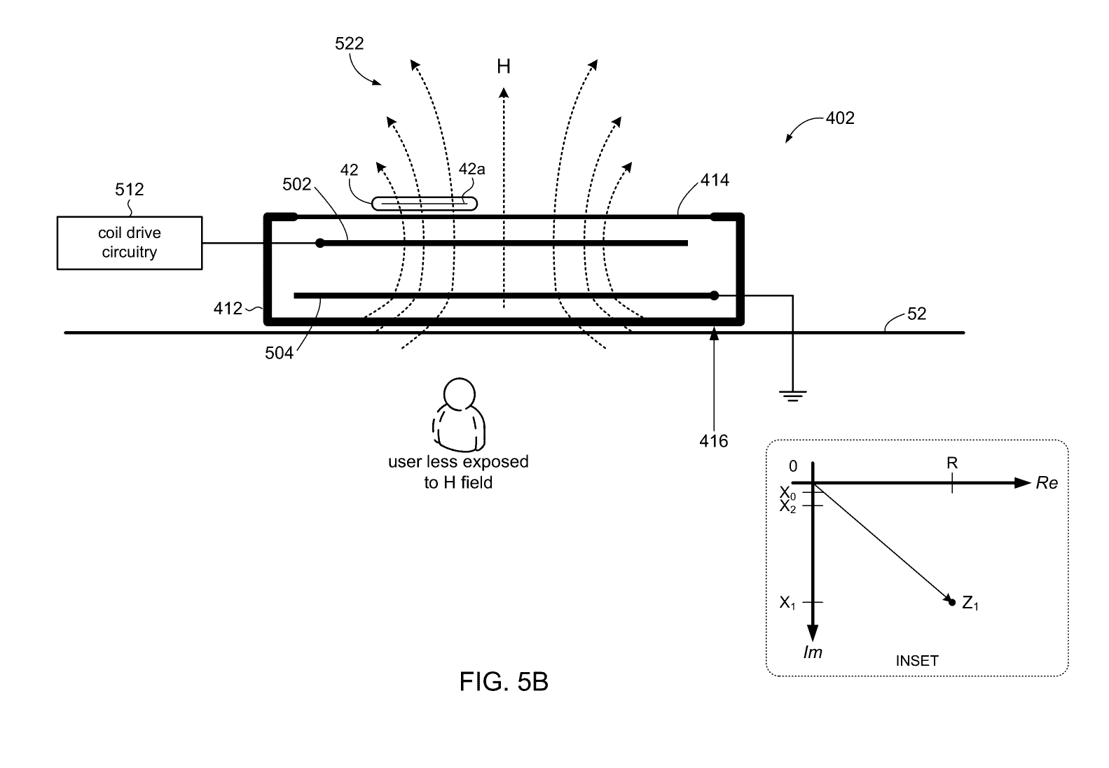

FIG. 5 shows details of transmitter 402. The figure is a representational schematic that depicts a cross-sectional view of transmitter 402 taken along view lines 5-5 shown in FIG. 4. The transmitter 402 may include means for generating a magnetic field. For example, the transmitter 402 may include a power transmitting element 502 disposed below the upper surface 414 of transmitter 402. As noted above, in some embodiments, for example, the power transmitting element 502 may be a coil of conductive material; e.g., copper wire, copper traces etched on a flexible printed circuit board (FPCB), and so on. In other embodiments, the power transmitting element 502 may comprise several coils of conductive material, connected together or operated independently.

The transmitter 402 may include coil drive circuitry 512 to provide power to the power transmitting element 502. The coil drive circuitry 512 may be incorporated within the housing 412. As noted above, the coil drive circuitry 512 may be configured to drive the power transmitting element 502 at, for example, a resonant frequency of the power transmitting element 502. The coil drive circuitry 512 may include tuning circuitry (e.g., 360, FIG. 3) to set a resonant frequency of the power transmitting element 502 to a suitable frequency; e.g., in some embodiments, the resonant frequency may be set according to an industry standard.

The transmitter 402 may include means for shielding the magnetic field from users. For example, the transmitter 402 may include electromagnetic (EM) shielding 504 disposed below the power transmitting element 502. In some embodiments, the shielding 504 may be connected to ground potential. The shielding 504 may be any suitable electrically conductive material. In some embodiments, for example, the shielding 504 may be metal layer comprising a sheet of copper or a copper alloy. In other embodiments, the metal layer may comprise other metals.

In accordance with the disclosure, the transmitter may include means for locally retuning the receiver. For example, a layer of ferrite 506 may be disposed between the power transmitting element 502 and the shielding 504. Any suitable ferromagnetic material may be used. In some embodiments, the layer of ferrite 506 may comprise individual pieces of ferrite. This aspect of the disclosure will be discussed in more detail below.

In operation, wireless transfer of power from the transmitter 402 to the receiver 42 may include the coil drive circuitry 512 providing an alternating current (AC) drive signal to the power transmitting element 502. In response, the power transmitting element 502 may generate a magnetic field 522, and in particular an AC magnetic field. The receiver 42 may include a power receiving element 42a (e.g., a coil of conductive material) that can couple to the magnetic field 522. The power receiving element 42a in the receiver 42 may be tuned (e.g., using suitable tuning circuitry) to the resonant frequency of the power transmitting element 502 in order to maximize mutual inductance between the transmitter 402 and receiver 42, and hence the power transferred to the receiver 42.

The electrical impedance of the power receiving element 42a in the receiver 42 may be expressed by the following:

Z=R+jX,

where, Z represents the electrical impedance of power receiving element 42a,

R represents the resistance of power receiving element 42a, and

X represents the reactance of power receiving element 42a.

The inset in FIG. 5 represents the impedance of the power receiving element 42a for the configuration of transmitter 402 shown in the figure. This aspect of the disclosure will be discussed below.

The shielding 504 serves as an EM shield to reduce electromagnetic interference (EMI) and/or exposure to the magnetic field 522. FIG. 5 schematically illustrates that the shielding 504 the field strength of the magnetic field 522 that emanates from the bottom surface 416 of the transmitter 402 may be reduced relative to the field strength of the magnetic field 522 that emanates from the upper surface 414.

In some instances, the transmitter 402 may be placed on the surface 52 of a table (not shown). When a user sits at the table, the shielding 504 may serve to reduce the field strength of the magnetic field 522 that the user can be exposed to. As comparison, FIG. 5A for example, shows a transmitter 402′ without shielding. FIG. 5A shows that the user can be exposed to a greater field strength of the magnetic field 522 than with shielding 504 (FIG. 5).

When shielding 504 is added to protect the user from exposure to the charging field (e.g., magnetic field 522), the presence of the shielding 504 may detune the receiver 42. This can be illustrated, for example, with reference to FIGS. 5A and 5B. Consider the transmitter configuration shown in FIG. 5A. Suppose the impedance Z of the power receiving element 42a is Z₀ (see the inset). Suppose further that the impedance value Z₀ sets the resonant frequency of the power receiving element 42a to match the resonant frequency of the power transmitting element 502. Since the resonant frequencies match, the impedance value Z₀ is shown being close to zero; theoretically, the impedance is zero.

Referring now to FIG. 5B, suppose that only shielding 504 is added to protect the user from exposure to the charging field (e.g., magnetic field 522). Since metal affects the inductance of nearby structures, the presence of the shielding 504 may change the inductance (and hence the reactance X) of the power receiving element 42a in the receiver 42. For example, the shielding 504 may change the reactance from a value X₀ (inset in FIG. 5A) to a value X₁, as shown in the inset in FIG. 5B. The shift in reactance X from X₀ to X₁ changes the resonant frequency of the power receiving element 42a, creating a mismatch with the resonant frequency of the power transmitting element 502. In particular, the shielding 504 may shift the reactance X of the receiver 42 in the negative direction, as shown in the inset, relative to not having the shielding 504.

The shift in reactance X detunes the receiver 42 (in particular, the power receiving element 42a) with respect to the power transmitting element 502. This detuning of receiver 42 can be problematic in terms of increasing the peak power point resistance and changing the output voltage that the power receiving element 42a can provide to the receiver 42 during wireless power transfer.

The addition of the layer of ferrite 506 (FIG. 5) can compensate for the change in the reactance X of power receiving element 42a due to the shielding 504. Referring to the inset in FIG. 5, for example, the layer of ferrite 506 can change the reactance value in the opposite direction, from a value X₁ to a value X₂, relative to not having the layer of ferrite 506. The shift in reactance X from X₁ in the direction towards X₂ tends to restore the resonant frequency of the power receiving element 42a. In particular, the layer of ferrite 506 may shift the reactance X of the receiver 42 in the positive direction, as shown in the inset. The positive shift in the reactance X can retune the receiver 42 (in particular, the power receiving element 42a) with respect to the power transmitting element 502. This retuning is illustrated in the inset by the closeness of impedance value X₂ to the original impedance value X₀. The shielding 504 influences the reactance of the receiver 42 one way while the ferrite 506 influences the reactance of the receiver 42 in an opposite way. The ferrite 506 is configured and disposed to offset the influence on the reactance X of the receiver 42 by the shielding 504, and thus the influence on the resonant frequency of the receiver 42 by the shielding 504. The offsetting may reduce the change in reactance X and resonant frequency that would occur absent the ferrite, and thus the ferrite 506 may not return the reactance X or resonant frequency of the receiver 42 to the reactance X or resonant frequency of the receiver 42 without the shielding. While the discussion refers to shifts in reactance and retuning of reactance, the influences of the shielding 504 and the ferrite 506 may not be sequential, with the influences occurring concurrently. The discussion of shifts and/or retuning includes concurrent influences by the shielding 504 and the ferrite 506.

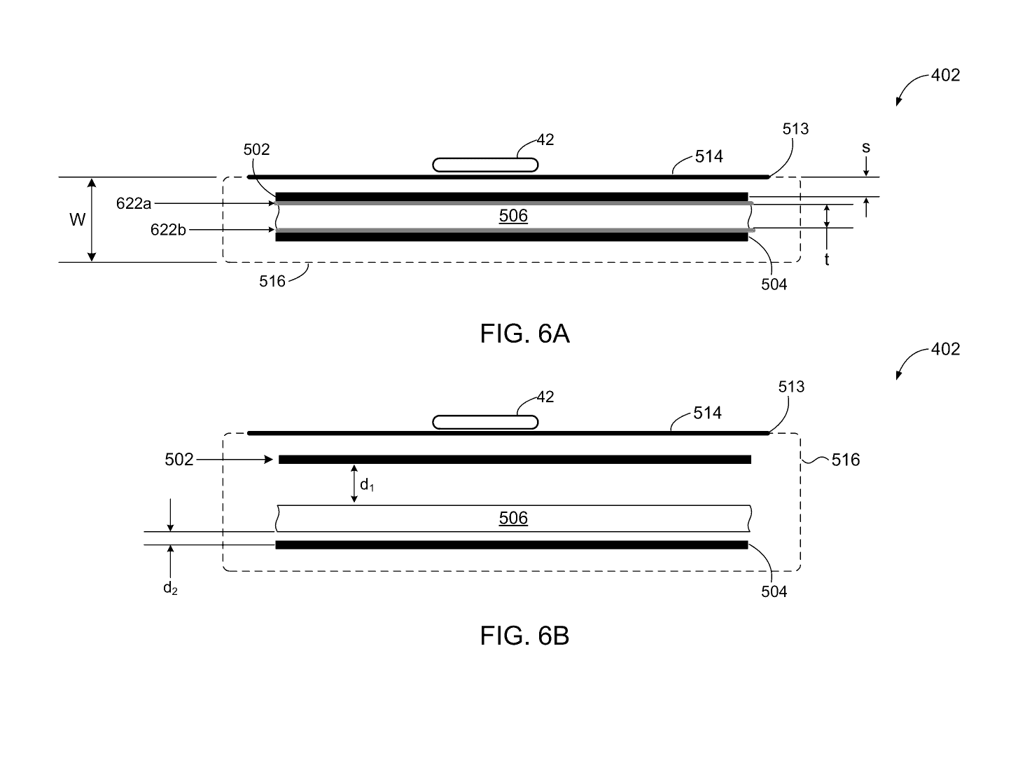

FIGS. 6A and 6B show some details of embodiments of the transmitter 402 in accordance with aspects of the disclosure. In some embodiments, such as shown in FIG. 6A for example, the layer of ferrite 506 may be stacked on the shielding 504. A suitable adhesive 622b may be applied to secure the layer of ferrite 506 to the shielding 504. Likewise the power transmitting element 502 may be stacked on the layer of ferrite 506. A suitable adhesive 622a may be applied to secure the power transmitting element 502 to the layer of ferrite 506.

It may be desirable (e.g., as a design aesthetic) for the housing 516 of the transmitter 402 to have certain mechanical aspects (e.g., low profile). The width W, for example, of the housing 516 may be controlled by controlling the spacing s between the power transmitting element 502 and a support member 513 that provides a charging surface 514. In addition, the thickness t of the layer of ferrite 506 may be thin enough to accommodate a desired housing width W, but sufficiently thick to make a difference in shifting the reactance X of the receiver 42. In addition, these design parameters, spacing s and thickness t, may be selected depending on a desired shift in the reactance of receiver 42.

FIG. 6B illustrates examples of design parameters in addition to spacing s and thickness t. For example, instead of being stacked on the layer of ferrite 506, the power transmitting element 502 may be spaced apart by a distance d₁ from the layer of ferrite 506. This spacing may be desirable to achieve a desired shift in the reactance of receiver 42. Likewise, the layer of ferrite 506 may be space apart from the shielding 504 by a distance d₂ in order to achieve a desired shift in the reactance of receiver 42. It will be appreciated that different combinations of the foregoing parameters may be selected to achieve a combined effect of shifting the reactance of receive 42 by a desired amount. For example, the distance d₂ may be smaller than the distance d₁ such that the layer of ferrite 506 is disposed closer to the shielding 504 than to the power transmitting element 502. The distance d₁ separating the power transmitting element from the layer of ferrite 506 may be two times, three times, five times, ten times, etc., the distance d₂ separating the layer of ferrite 506 from the shielding 504. The layer of ferrite 506 is preferably disposed adjacent to, e.g., adhered to, the shielding 504, e.g., with the distance d₂ being a thickness of an adhesive. The distance d1 is preferably larger than a thickness of an adhesive, and is preferably as large as possible within the housing width W.

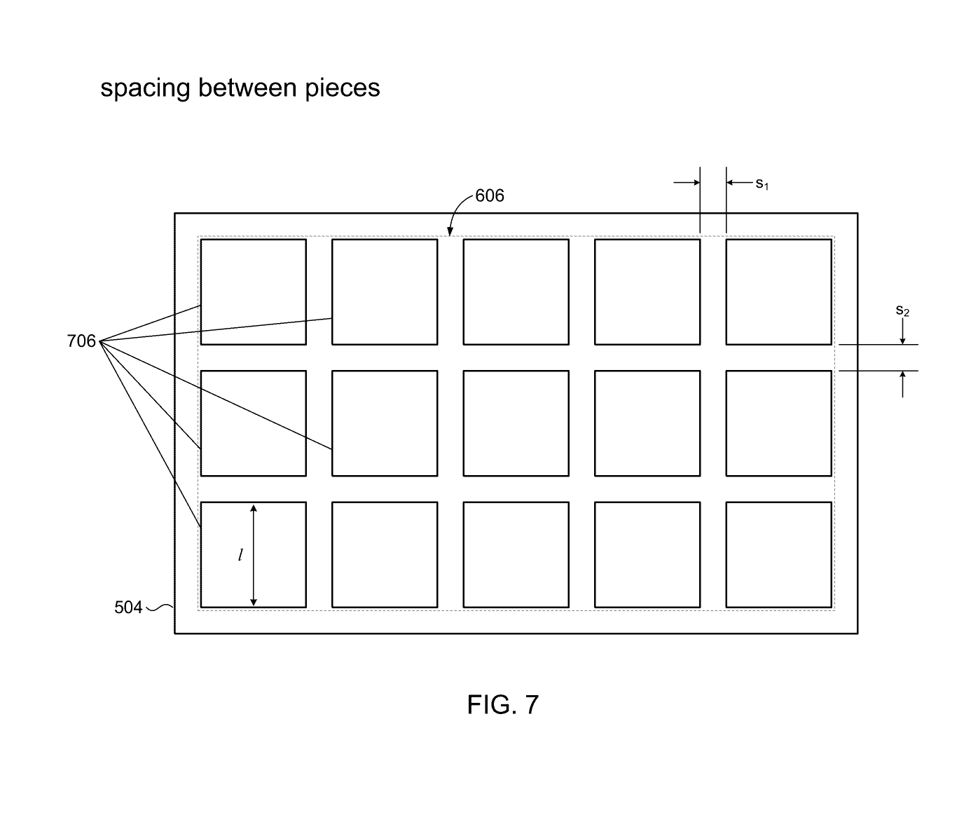

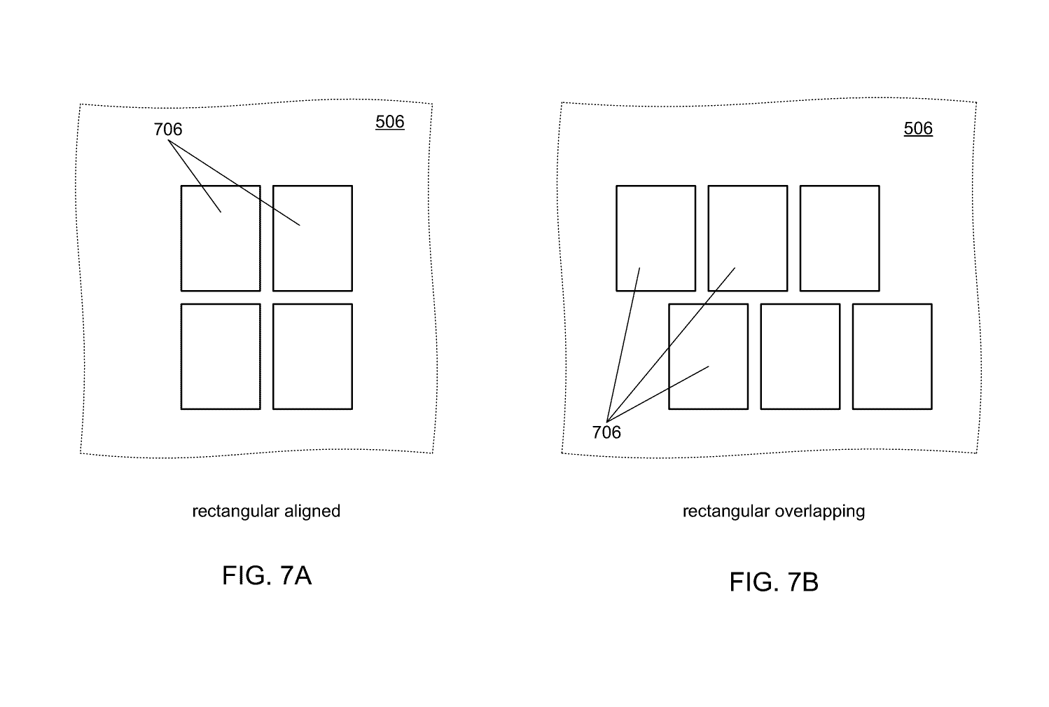

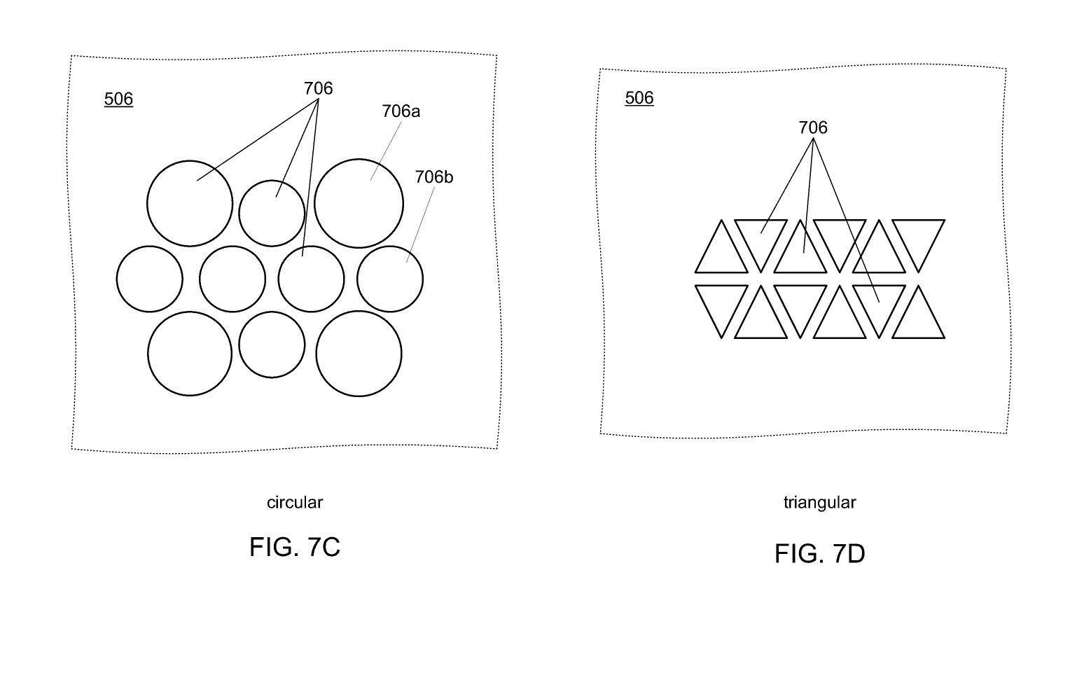

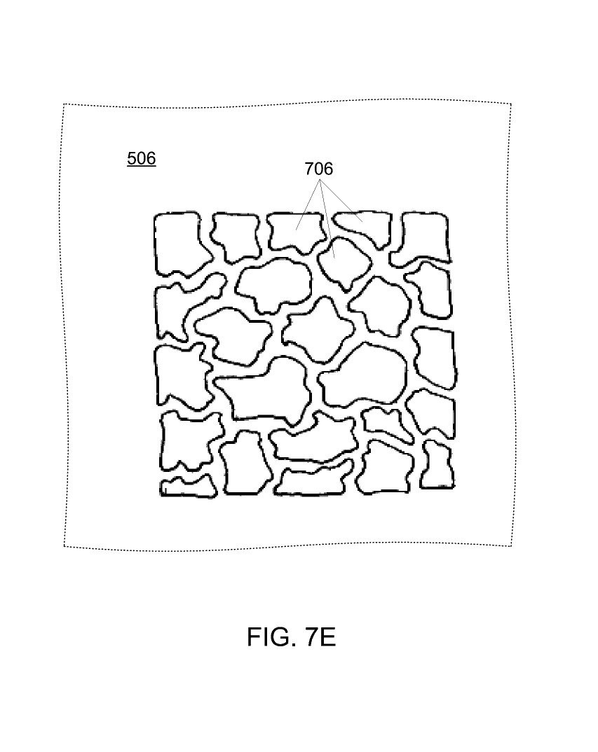

FIG. 7 shows some details of the layer of ferrite 506 in accordance with the disclosure. For example, the layer of ferrite 506 may comprise pieces of ferrite material (ferrite pieces) 706. In some embodiments, the ferrite pieces 706 may be squares of length l. The ferrite pieces 706 may be arranged on the shielding 504 in a regular pattern, i.e., in rows and/or columns with the ferrite pieces 706 equally spaced in each row and/or column, respectively, such that each of the ferrite pieces 706 in a row is spaced apart by a distance, s₁, from its row neighbor(s) and each of the ferrite pieces 706 in a column is spaced apart by a distance, s₂, from its column neighbor(s) (i.e., adjacent ferrite pieces 706 are spaced apart by the distances s₁, s₂). The row and column spacings s₁, s₂, may be the same or different, but are preferably uniform across each row and column, respectively. The ferrite pieces 706 may be arranged in rows but not columns, or vice versa, with adjacent ones of the ferrite pieces 706 in the rows (or columns) being equally spaced but the rows (columns) offset such that the ferrite pieces 706 are not in columns (rows). Alternatively, the ferrite pieces 706 may be arranged in an irregular pattern with non-uniform spacing (e.g., at least one dissimilar row spacing and/or column spacing, more than two different spacings, etc.) between the ferrite pieces 706. The spacing of the ferrite pieces 706 exposes the shielding 504 to the power transmitting element 502 while the ferrite pieces 706 compensate for the reactance affect of the shielding on the reactance of the coil of the receiver. The spacing of the ferrite pieces 706 is preferably smaller than the sizes of the ferrite pieces 706 such that while the shielding 504 is exposed to the power transmitting element 502, most of the surface of the shielding 504 is overlaid by the ferrite pieces 706. The spacings between the ferrite pieces 706 are preferably small relative to sizes of the ferrite pieces 706, e.g., with spacings being less than 25% (or less than 10%, or less than 5%) of a length or width of the ferrite pieces 706.

In operation, the ferrite pieces 706 may have the effect of locally altering the reactance of the receiver (e.g., 42, FIG. 6A). That is, the ferrite pieces 706 each incrementally change or affect the reactance of a respective portion of the receiver, and the cumulative effect on the reactance of the receiver as a whole is an averaging of the multiple local effects on the reactance of each of the portions of the receiver. For example, the ferrite pieces 706 may be sized to be smaller than a coil of the receiver to have local effects on the reactance, and then each additional ferrite may incrementally change the value of the reactance with multiple reactance effects being averaged over the coil of the receiver. For example, the ferrite pieces 706 may be sized to have a longest dimension that is less than a longest (or a shortest) planar dimension of the coil of the receiver. Preferably, the longest dimension of the ferrite pieces 706 is much less than the longest (or shortest) planar dimension of the coil of the receiver, e.g., less than half, less than a quarter, less than 10%, or less than 5% of the longest dimension of the coil of the receiver. Also or alternatively, areas of the ferrite pieces 706 may be smaller than an area of the coil of the receiver, e.g., less than 50%, less than 25%, less than 10%, or less than 5% of the area of the coil of the receiver.

In accordance with the disclosure, the ferrite pieces 706 may have other shapes and arrangements. FIGS. 7A-7D shows some illustrative examples of shapes and arrangements of ferrite pieces 706 that may comprise the layer of ferrite 506 in accordance with various embodiments of the disclosure, other than square-shaped pieces. For example, the ferrite pieces 706 may be rectangular in shape and aligned in a “street” pattern such as depicted in FIG. 7A. FIG. 7B shows that the ferrite pieces 706 may be rectangular-shaped and arranged in an overlapping pattern. FIG. 7C shows that the ferrite pieces 706 may be circular. FIG. 7C further illustrates that in some embodiments, the ferrite pieces (e.g., 706a, 706b) may be different sizes. FIG. 7D shows the ferrite pieces 706 may be triangular-shaped, and so on. The size, shape, and spacing of ferrite pieces 706 may be varied across the area of the layer of ferrite 506 in order to locally compensate the reactance shift. As shown in FIGS. 7 and 7A-7D, the ferrite pieces 706 may have regular shapes, with interior angles of the shapes being equal (and with sides that are equal in length (e.g., squares) or inequal in length (e.g., non-square rectangles)). Also or alternatively, referring also to FIG. 7E, the ferrite pieces may have irregular shapes (e.g., with sides of inequal length and/or inequal interior angles). The spacing of the ferrite pieces 706 may be non-uniform, particularly if one or more of the ferrite pieces 706 are irregularly shaped. Further, some of the ferrite pieces 706 may have regular shapes and some have irregular shapes. The shapes of the ferrite pieces 706 may be similar (e.g., all circles or all rectangles, even if of different sizes). Alternatively, the ferrite pieces 706 may have dissimilar shapes, e.g., dissimilar regular shapes (e.g., some circles and some rectangles), or some regular shapes and some irregular shapes, or irregular shapes that are dissimilar, or combinations of these.

The ferrite pieces 706 may be configured such that an area of the of ferrite pieces 706 and an area of the shielding 504 are substantially the same size. For example, a cumulative area of the ferrite pieces may cover more than 50% of an area of the shielding 504. As another example, the ferrite pieces 706 may be disposed across an entirety of the shielding 504 except for the spacings of the ferrite pieces 706, e.g., such that the ferrite pieces 706 extend to the edge(s) of the shielding 504 except for the spacings.

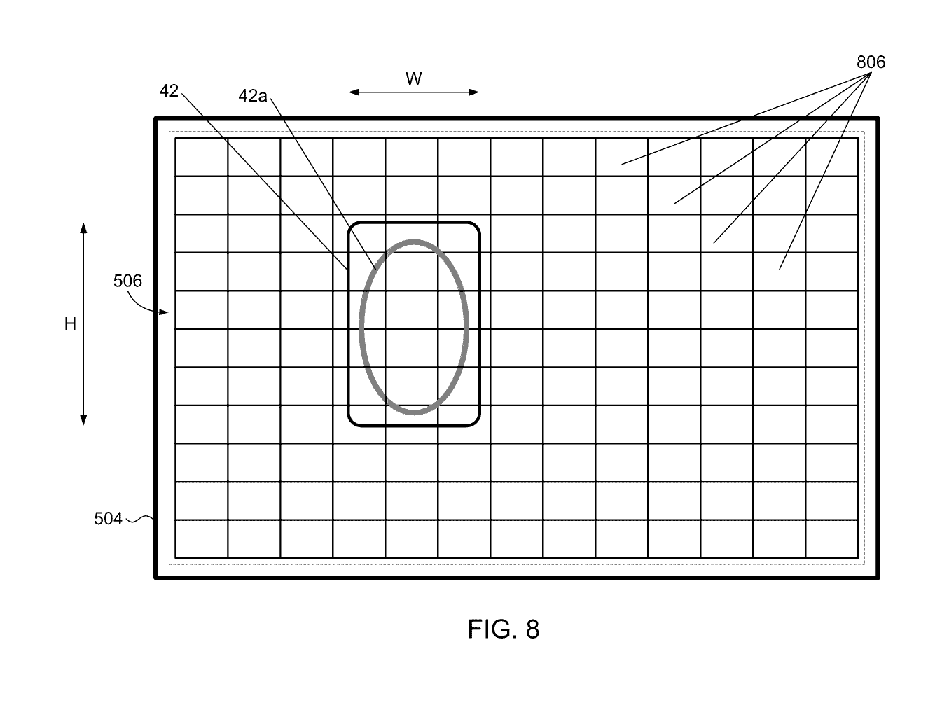

FIG. 8 shows an aspect of the layer of ferrite 506 in accordance with the disclosure. The ferrite pieces 806 that comprise the layer of ferrite 506 may have dimensions sufficiently small relative to the power receiving element 42a in the receiver 42 so that several ferrite pieces 806 can span the dimensions of the power receiving element 42a. The illustrative embodiment of FIG. 8, for example, shows that three of the ferrite pieces 806 span a width dimension (W) of the power receiving element 42a, and six of the ferrite pieces 806 span a height dimension (H) of the power receiving element 42a.

The above description illustrates various embodiments of the disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the disclosure as defined by the claims.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

What is claimed is:

1. An apparatus for wireless power transfer, the apparatus comprising:
a support member including a charging surface configured to support a power receiving element;
a power transmitting element configured to generate a magnetic field that can wirelessly transfer power to the power receiving element;
a metallic shield disposed such that the power transmitting element is disposed between the support member and the metallic shield, the metallic shield being configured to inhibit the magnetic field generated by the power transmitting element; and
a plurality of ferrite pieces spaced apart from each other and disposed between the power transmitting element and the metallic shield and closer to the metallic shield than to the power transmitting element, the plurality of ferrite pieces offsetting an effect of the metallic shield on a reactance of the power receiving element.

2. The apparatus of claim 1, wherein the effect of the metallic shield on the reactance of the power receiving element changes a value of the reactance in a first direction, and wherein each of the plurality of ferrite pieces incrementally changes the value of the reactance in a direction opposite the first direction such that an averaging of the changes offset the effect of the metallic shield on the reactance of the power receiving element.

3. The apparatus of claim 1, wherein each of the plurality of ferrite pieces has an area that is smaller than an area of a receiver coil of the power receiving element.

4. The apparatus of claim 3, wherein the area each of the plurality of ferrite pieces is less than half of the area of the receiver coil of the power receiving element.

5. The apparatus of claim 1, wherein each of the plurality of ferrite pieces has a regular shape.

6. The apparatus of claim 1, wherein the plurality of ferrite pieces are the same size as each other.

7. The apparatus of claim 1, wherein an area of the plurality of ferrite pieces and an area of the metallic shield are substantially the same size.

8. The apparatus of claim 1, wherein an area of the plurality of ferrite pieces is substantially the same size as an area of the charging surface.

9. The apparatus of claim 1, wherein the ferrite pieces extend over 85% of a length of the metallic shield.

10. The apparatus of claim 1, wherein the ferrite pieces extend over 80% of an area of the metallic shield.

11. The apparatus of claim 1, wherein the ferrite pieces are adhered to the metallic shield.

12. The apparatus of claim 1, wherein the metallic shield is configured and disposed to reduce the reactance of the power receiving element.

13. The apparatus of claim 12, wherein the plurality of ferrite pieces are configured and disposed to increase the reactance of the power receiving element.

14. A method for wireless power transfer, the method comprising:
generating, from a power transmitting element, a magnetic field for wireless transfer of power to a power receiving element above the power transmitting element;
shielding the magnetic field below the power transmitting element using a metal layer, the metal layer influencing a reactance of the power receiving element in a first direction; and
locally influencing the reactance of the power receiving element in a second direction at a plurality of locations across the power receiving element to compensate for an influence of the metal layer on the reactance of the power receiving element.

15. The method of claim 14, wherein locally changing the reactance of the power receiving element includes changing the reactance in a direction opposite the first direction.

16. The method of claim 14, wherein shielding the magnetic field decreases the reactance of the power receiving element.

17. The method of claim 16, wherein locally influencing the reactance of the power receiving element increases the reactance of the power receiving element.

18. The method of claim 14, wherein locally influencing the reactance of the power receiving element includes influencing the reactance of the power receiving element using a plurality of ferrite pieces spaced apart from each other, disposed between the power transmitting element and the metal layer, and disposed closer to the metal layer than to the power transmitting element.

19. The method of claim 18, wherein each of the plurality of ferrite pieces is smaller than a coil of the power receiving element.

20. The method of claim 18, wherein the plurality of ferrite pieces all have a regular shape.

21. The method of claim 18, wherein the plurality of ferrite pieces are the same size as each other.

22. The method of claim 18, wherein the plurality of ferrite pieces encompass substantially an entire area of the metal layer.

23. The method of claim 18, wherein an area of the plurality of ferrite pieces is substantially the same size as an area of a charging surface on which the power receiving element is placed.

24. An apparatus comprising:
means for supporting a power receiving element;
means for generating a magnetic field for wireless transfer of power to the power receiving element;
means for shielding the magnetic field, the means for shielding configured to have a detuning influence on the power receiving element to influence a resonant frequency of the power receiving element away from a desired resonant frequency; and
means for locally retuning the power receiving element at a plurality of locations on the means for shielding to influence the resonant frequency of the power receiving element toward the desired resonant frequency.

25. The apparatus of claim 24, wherein the desired resonant frequency is a resonant frequency of the means for generating the magnetic field.
